(19) United States
(12) Patent Application Publication
(10) Pub. No.: US 2005/0138129 A1
(43) Pub. Date: Jun. 23, 2005

(54) Methods and systems of responsive messaging

(76) Inventors: Maria Adamczyk, Alpharetta, GA (US); Arnold Chester McQuaide JR., Berkeley Lake, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/745,199

(22) Filed: Dec. 23, 2003

(51) Int. Cl. G06F 15/16

(52) U.S. Cl. 709/206

(57) ABSTRACT

Methods and systems for responding to messages such as electronic mail messages. Based on a request to send a response to an e-mail, the e-mail originator address may be used to determine the recipient. The recipient's presence or active use of a device is checked such as by consulting a presence server or a home location register (HLR), if a wireless device. The response is sent via a response mode corresponding to such presence or active use. The response modes may be organized hierarchically. If a recipient is present or actively using more than one device, the response mode having highest priority in the hierarchy is used. The response modes may include e-mail, paging, or wireline or wireless communications. The recipient may be provided with an option to call the originator of the response. If the recipient selects the option, a call may be routed from the recipient to the originator.

### FIELD OF THE INVENTIONS

The inventions generally relate to the routing of communications, particularly, responsive communications, and more specifically may relate to the priority routing of communications based on a hierarchy of response modes and the presence or active use of communication devices by recipients.

### BACKGROUND OF THE INVENTIONS

At certain times, there is a need to respond immediately to a received electronic mail message (e-mail) or other communication. For example, a person may receive an e-mail from a client referring to a meeting scheduled later in the day, but the e-mail may have the place of the meeting incorrectly noted. The client plans to attend the meeting at location X, rather than the correct location Y. The person would like to correct the mistake and get the right information regarding the place of the meeting to the client as quickly as possible and in time for the parties to meet as scheduled.

The problem is the person is not assured a responsive message will be reviewed by the client in time to correct the mistake as to the meeting's location. The person could reply by e-mail to the received e-mail including the incorrect meeting location. The client, however, may not be using his or her computer or other e-mail device at the time the person sends the reply e-mail or at any time before the meeting. So, the client may miss the corrective reply e-mail and may miss the meeting. The person could call the client, but the client may be unavailable by phone—whether wireline or wireless. The person may be able to leave a voicemail message, but as with the reply e-mail, the client may not review the message in time. The same problem relates to a page the person may send to the client. The client may not review the page in time to make the meeting at the correct location.

To cover all bases, the person may try to communicate with the client in every possible way to correct the information about the meeting's location. The person may send a reply e-mail; the person may call all telephone numbers associated with the client and leave voicemails or other messages; and the person may send a page or other data messages, if the client has such devices. These communications involve a lot of time and effort. The person must prepare and send the reply e-mail with the correct information. The person must find the appropriate telephone and pager numbers associated with the client. The person must make separate calls to each number. The person must leave separate voicemails with respect to each telephone number that he or she calls. Despite these efforts, the person may be unable to determine whether the correct information on the location of the meeting has been reviewed on a timely basis by the client.

Accordingly, there is a need for a way for a person to communicate information efficiently and in a manner most likely to lead to review of the information on a timely basis by the recipient of the communication.

### SUMMARY OF THE INVENTIONS

The inventions relate to messaging systems, and particularly, to messaging systems that allow for messages such as responsive messages that are transmitted quickly and efficiently to destinations where the messages are most likely to be reviewed on a timely basis by the recipients. Depending on the active use of a communications device by the recipient, the responsive message may be an e-mail, a telephone call (wireline or wireless), page, and/or other type of message.

Advantageously, a person may respond to an e-mail almost instantly and have the response directed to a device being actively used by the recipient. Thus, the response may be reviewed by the recipient on a timely basis with respect to the contents of the response. The person sending the response does not have to “cover all the bases” by sending a responsive e-mail, calling each of the recipient's wireline and/or wireless devices and leaving voicemails, and/or sending pages or other messages. Therefore, the person sending the response saves time and effort and is provided with relative assurance the response has been communicated in a manner most likely to lead to the recipient's timely review of the communication. Moreover, the person sending the response may receive confirmation of the recipient's review of the response.

Generally stated, the inventions check for the presence or active use of a communications device by a person or entity who is to receive a communication from the originator. The communication is transmitted in the response mode corresponding to a device being actively used by the recipient. If the recipient is present or actively using more than one device, the communication may be transmitted via the response mode having the highest priority as previously determined. The recipient's review of the response may be confirmed by communication to the originator.

More specifically, the inventions include an exemplary method relating to the transmission of a response to an e-mail. The recipient of the response may be determined from the e-mail. Information regarding the recipient's communications devices may be stored in association with or corresponding to the identity of the recipient. The information may include response modes. For example, the recipient may be able to receive a response in a response mode of e-mail, paging, and/or wireline or wireless communications. The response modes of a recipient may be organized hierarchically including a first choice of response mode and second choice of response mode.

The recipient's presence or active use of a device is checked by using the information regarding the recipient's communications devices. For example, a presence server (with respect to e-mail or other data communications), or a home location register (HLR), if a wireless device, may be checked for the presence or active status of the recipient. A response is sent to the recipient via a response mode corresponding to such presence or active use. If a recipient is present or active on a device corresponding to the first choice of response mode and to the second choice of response mode, then the response is transmitted in the response mode of first choice because of its place in the hierarchy of response modes. Advantageously, the originator may receive confirmation of the recipient's review of the response.

The inventions include alternatives for the contents of the response. Optionally, the response may include a call to the communications device of the recipient and include an announcement or otherwise provide the recipient with an option to hear the substance of the response. As another option, the user of the communications device may be provided with an opportunity to call the originator of the response. The user may exercise the option by indicating a selection of the option. In response to the selection of the option to call the originator of the response, a call may be routed from the communications device of the user to a device being used by the originator of the response.

The inventions also include an exemplary system for transmitting a response to an electronic mail message (e-mail). The exemplary system includes a response module having information associated with a user. The user information may include identities of possible recipients of responses or other messages from the user. One or more response modes may be associated with each recipient, and may be organized based on a priority hierarchy. In response to a request by the user to send a response to a recipient, the response module may determine an active response mode associated with the recipient. For example, the response module may consult a presence server to determine whether the recipient is active on a data communications device such as a computer. As another example, the response module may consult an element of a wireless network such as a home location register (HLR) to determine whether the recipient has activated his or her wireless device or unit. The response module then may transmit the response by using the active response mode. Advantageously, the review of the response by the recipient may be confirmed to the user.

The inventions include another exemplary method for sending a message. This exemplary method stores response modes for sending messages in association with the identity of recipients of the messages. In response to receiving a request to send a message with respect to a received electronic mail message (e-mail), the received e-mail is used to determine a recipient for the message. An active device of the recipient may be determined by checking with a presence server and/or with a home location register (HLR). A message is sent to the recipient in a response mode corresponding to an active device of the recipient. Optionally, the message may be an announcement to the recipient of the option to call an originator of the message. In response to the exercise of the option by the recipient, a call may be routed from a communication unit of the recipient to a communication unit of the originator. Further, the originator of the message may be provided with confirmation of the review of the message by the recipient.

In sum, the inventions generally provide for messages, such as response messages, that may be transmitted quickly and efficiently to destinations where the messages are most likely to be reviewed on a timely basis by the recipients.

### BRIEF DESCRIPTION OF THE DRAWINGS

FIG. 1 illustrates an exemplary environment including an example of a system of the inventions.

FIG. 2 is a flow diagram of an exemplary method according to the inventions.

### DETAILED DESCRIPTION OF THE INVENTIONS

Generally stated, the inventions relate to messaging systems, and particularly, to messaging systems that allow for messages, especially responsive messages that are transmitted quickly and efficiently to destinations where the messages are most likely to be reviewed immediately or at least on a timely basis by the recipients.

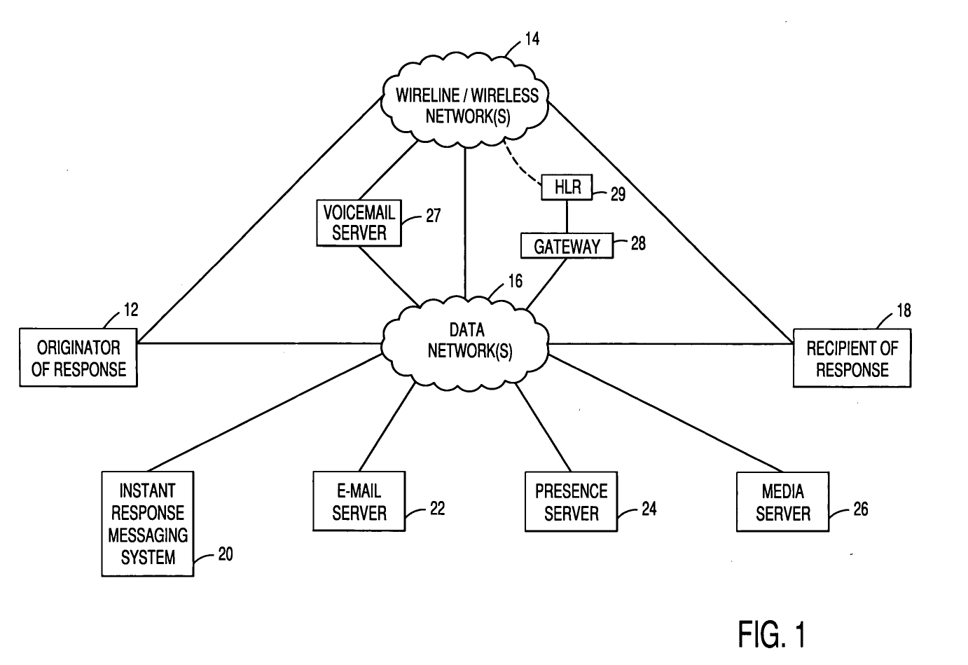

Exemplary Environment for the Operation of the Inventions—FIG. 1

FIG. 1 illustrates an exemplary environment for the operations of the inventions. An originator 12 may transmit a message, such as a response (also referred to as response message or responsive message) to a message such as an electronic mail message (e-mail) via communication networks such as a wireline and/or wireless network(s) 14 and/or a data network(s) 16 and/or other network(s) (not illustrated) to the recipient 18 of the message. The originator 12 may be a person or entity using one or more communications devices. The communications devices may include a computer or other data communications device, a wireline device such as a telephone, a wireless device such as mobile telephone or personal computer, a personal digital assistant (PDA), a pager, or the like.

Where the response by the originator 12 is transmitted in reply to an e-mail, the originator 12 typically is using a data communications device such as a computer, personal digital assistant (PDA), or other device capable of e-mail and/or other communications with the appropriate software or other functional elements for carrying out such communications. The originator 12 also may have available to him or her (with or instead of the computer, PDA, or other device, or otherwise) other communications devices for the transmission of the message, in combination with the data communications devices or otherwise, such as a response including a wireline telephone (also referred to as unit or device), a wireless unit (also referred to as unit or device), a pager, a personal digital assistant (PDA), or like communications device.

The communication network(s) 14 may be, may include, or may be part of the public switched telephone network (PSTN), wireless networks, or other similar networks. The data network(s) 16 may be, may include, or may be part of a local area network (LAN), wide area network (WAN), an intranet, global data communications network such as the Internet, or otherwise.

Other elements that may be used in carrying out the exemplary embodiments of the inventions may include an instant response messaging (IRM) system 20, an e-mail server 22, a presence server 24, and a media server 26. As illustrated in FIG. 1, each of these system 20 and servers 22, 24, and 26 may be accessed by or connected to the data network(s) 16. As illustrated in FIG. 1, the system 20 and the servers 22, 24, and 26 are separate devices separately connected to the data network(s) 16. But the system 20 and the servers 22, 24, and 26, and their respective functionalities and features, should not be so limited. The system 20 and servers 22, 24, and 26 may be organized as a single device, may have their respective features and functionalities distributed among each other, or other devices, or among the communications network 14 or the data network(s) 16, or otherwise.

Yet other elements that may be used in carrying out the exemplary embodiments of the inventions may include a voicemail server 27, a gateway 28, and a home location register (HLR) 29. In the exemplary embodiment illustrated in FIG. 1, the voicemail server 27 is shown as connected to the communications networks (14) as well as the data network(s). Of course, the voicemail server 27 may be otherwise connected as appropriate to the circumstances such as being only connected to the communications networks (14), or to the data network(s) 16, or otherwise. Moreover, the voicemail server 27 is not necessarily a separate element as illustrated in FIG. 1, but may be incorporated, connected to, and/or distributed among one or more elements of the communications network(s) 14 and/or the data network(s) 16.

As noted, a gateway 28 and a home location register (HLR) 29 may be used in carrying out the exemplary embodiments of the inventions. As illustrated in FIG. 1, the gateway 28 may be connected to the data network(s) 16 and through the HLR 29 (or otherwise) to the communications network(s) 14. The gateway 28 may function effectively as a translator between the data network(s) 16 and communications network(s) 14. In particular, the gateway 28 may facilitate the communications between the data network(s) 16 and the HLR 29. The gateway 28 may be a voice/data gateway such as a VoiceXML Gateway (also referred to as a “voice browser” or VOXML). Further, the gateway 28 may be connected to the communications network(s) 14 and the data network(s) 16 through elements that include features or functionalities such as automatic speech recognition (ASR) and/or text-to-speech (TTS) (ASR/TTS).

Generally, the inventions and exemplary embodiments thereof may be made available to the public on a subscription basis. For example, the originator 12 may be a subscriber to an “instant response messaging system” or service as (wholly or partially) implemented through the element of same name 20 as illustrated in FIG. 1 or otherwise. A subscriber to the instant response messaging (IRM) system (also referred to as IRM service) generally may reply to a received e-mail with an “instant response” that is routed via a response mode to a recipient (typically the author of the e-mail to the subscriber) based on the recipient's active/presence status regarding his or her use of a communications device. In an exemplary embodiment of the inventions, the subscriber may be offered the option of sending an “instant response” to a message. Alternatively, the subscriber may access the IRM service by selecting an action item or by entering a predetermined code or otherwise.

An IRM service, according to an exemplary embodiment of the inventions, differs from conventional services that allow a user to respond to messages. Among the differences is the functionality of the IRM service in checking for the presence or active use of a communications device by the recipient of the response message. The IRM service routes the response message to the device actively being used by the recipient. If the recipient is not present or actively using any device, then the response message may be routed to a default destination associated with the recipient such as an e-mail address.

Upon subscription, the subscriber may provide information with respect to potential recipients of messages including response messages. In some cases, the potential recipients of the response messages may have to agree or provide authorizations so the subscriber may be able to provide proof, if need be, of the potential recipients' agreement for inclusion with respect to the subscriber's activities in responsive messaging. Further, the potential recipients may have to take some action with regard to being included as a potential recipient with respect to the subscriber's responses. For example, a potential recipient may have to authorize his or her systems and/or communications devices to allow for receipt of the responses of the subscriber.

The subscriber may identify individuals or entities as recipients. With respect to each individual or entity, the subscriber may identify one or more response modes for communication with the individual or entity. For each response mode, the subscriber may provide the appropriate addressing/identification information for the response mode. For example, a subscriber may identify a friend with respect to the instant response messaging system or service. The friend may be identified by name, address, telephone number, wireless number, identification number, pager number, e-mail address, and/or the like.

Further, the friend (i.e., the identification of the friend) may be associated with one or more response modes. For example, the friend may be associated with response modes including e-mail, wireline call, wireless call, page, etc. For each mode, appropriate identification information for transmitting the response or message may be included. As noted, the friend may have to authorize the inclusion of this information and the actions of the responsive messaging service. The friend's authorization may be included as part of the information associated with the friend in the subscriber's information relating to his or her subscription to IRM services.

Further, the response modes with respect to a recipient may be ordered such as in a hierarchical order. The order in the hierarchy may be provided by the subscriber. For example, the response modes with respect to a recipient may be ordered with a wireless communication as a first choice, a page as a second choice, a wireline communication as a third choice, and an e-mail communication as a fourth choice. Even though four response modes have been described in the previous example, the inventions should not be so limited. A single response mode may be associated with recipient. Alternatively, more than one response mode may be associated with a recipient, and those response modes may or may not be organized based on a hierarchy. Further, a default response mode may be associated with a recipient. The default response mode may be the same for each recipient associated with a subscriber, or the default response mode may be specifically selected for each recipient associated with a subscriber.

If the subscriber does not rank the entries within the hierarchy, or even if the subscriber provides such a ranking, an exemplary embodiment may rank the entries in the hierarchy, or may select a mode of response arbitrarily, or for other reasons. As yet another alternative, the subscriber may provide the response modes regarding a particular recipient, but may not necessarily rank the response modes in any kind of a hierarchy, but rather, leave it up to the IRM system, depending on the circumstances at the time of transmission of the response, to determine the mode for transmitting the response with respect to a hierarchy among the entries of response modes associated with a recipient. Thus, at the time of transmission of the response, the IRM service may determine a hierarchy among the entries corresponding to the recipient. The hierarchy, and therefore the order of sending a response by any particular mode, may be based on considerations such as network traffic in one or more of the networks involved, or by other considerations. For example, at the time of a particular response, the network traffic or other reasons may be the basis for sending the response from the subscriber according to a particular mode rather than another mode associated with the recipient. As another example, at the time of a particular response, it may be quicker to send the response via particular mode rather than another mode associated with the recipient.

Moreover, the inventions contemplate different levels of subscription to the IRM service. For example, a subscriber to an IRM service may be characterized as a “basic” subscriber. If the basic subscriber transmits a response to a recipient, the IRM service may transmit the response based on a hierarchy of response modes as specified by the basic subscriber. Thus, the IRM service does not evaluate the differences among the response mode entries with respect to the recipient as identified by a basic subscriber. The IRM service transmits a response from a basic subscriber according to a first response mode as specified by the basic subscriber even though network traffic or other considerations would result in a faster transmission of the response in another response mode.

As another example, a subscriber to an IRM service may be characterized as a “premium” subscriber. If the premium subscriber transmits a response to a recipient, the IRM service may check among the response modes associated with the recipient to determine the fastest or most effective manner of transmission of the response. Thus, the IRM service transmits the response according to the fastest (or most effective) manner of transmission of the response given the circumstances and indications of the subscriber (and/or the recipient).

A subscriber's list of potential recipients of messages and related information may be referred to as a contact database. Moreover, a subscriber's contact database may include entries as specifically chosen by the subscriber, as provided by one or more databases or other sources for recipients of recipients, or a combination thereof.

A subscriber's contact database may be stored by the subscriber in and/or connected to one or more of his or her devices. Alternatively, and/or in addition, a subscriber's contact database may be stored in an element as part of either a data and/or communications network. As yet another alternative, and/or in addition, a subscriber's database may be based upon and/or derive information from a database (or other information source) to which the subscriber subscribes or belongs, has access, or which is available to subscribers to the IRM service or otherwise. For example, assume a person may have the IRM service available to him or her as a result of his or her employment, or other affiliation. As a result, the person may have a database or a subset of potential recipients based upon his employment or other affiliation. As another example, a person's subscription to the IRM service may be based on a common characteristic among other subscribers. Thus, the person may have a contact database for responses including others who subscribe to the IRM service and who have the common characteristic.

Regardless of the physical location of the contact database, it should be available for use in carrying out the response messaging of the exemplary embodiments.

An exemplary embodiment of the inventions implements an IRM service in part through provision and use, as illustrated in FIG. 1, of an instant response messaging (IRM) system 20 that is connected to the data network(s) 16. The IRM system 20 may implement the response messaging functionalities described herein. The IRM system 20 may be software based, but not necessarily or necessarily exclusively software based. The IRM system 20 may monitor and carry out functionalities of response messaging for subscribers such as originator 12 through the IRM system's connection to the data network(s) 16. FIG. 1 illustrates the IRM system 20 as a separate element connected to the data network(s), but the IRM system 20 should not be so limited. The IRM system 20 may be included or may be a part of another element(s) or network(s).

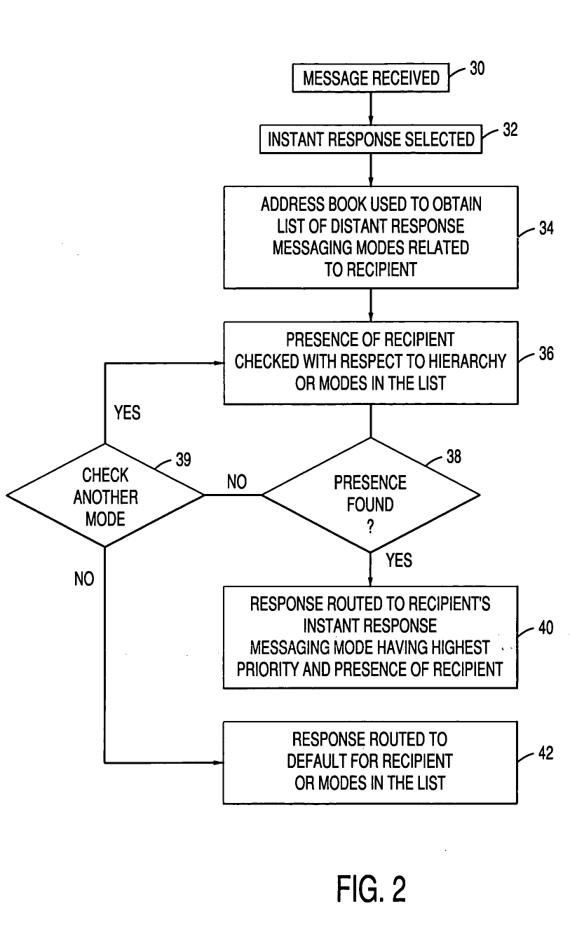

Additional examples of response messaging features of the exemplary embodiments are provided below in connection with a description of the flow diagram of FIG. 2.

Flow Diagram of an Exemplary Embodiment—FIG. 2

FIG. 2 illustrates an exemplary embodiment of actions that may be taken according to variations of the inventions. For example, in FIG. 2, a message is received in action 30. The person or entity or who received the message (also referred to as subscriber) decides in action 32 to provide a response. Because the subscriber is providing the response, the subscriber may be referred to as the originator of the response as indicated in FIG. 1. In an exemplary embodiment, the message that is received and to which a response may be sent is an e-mail message received on one or more of the subscriber's e-mail devices such as a computer, or other device. But the message to which an instant response may be sent is not limited to an e-mail message. Other types of messages may also engender an instant response and these other types may include other data messages such as instant messages, wireline/wirelss messages, pages and voicemail messages. Of course, response messaging to types of messages other than e-mails may require involvement of the wireline/wireless network(s) and other systems and networks in providing information from or about the messages to be used in the response messaging and otherwise.

Referring again to FIG. 2, in response to the subscriber's decision to send a response to a message, the exemplary embodiment uses information from the message received by the subscriber to determine the identity of the recipient of the response message. The identity of the recipient is used in action 34 to obtain information associated with the recipient. This information may include the response modes available with respect to the recipient for sending the response. The information may be stored in the contact database referenced above in connection with FIG. 1. The information stored in association with recipients of response messages also may be stored in an address book or similar storage mechanism.

As an example illustrating the flow diagram of FIG. 2, assume a recipient's name is associated with a list including two different response modes: wireless communication and e-mail. Also in this example, assume the wireless communication response mode has a higher priority than the e-mail response mode.

In action 36, the exemplary embodiment checks whether the recipient is present or actively using a device associated with a response mode. When the response modes are listed in order of priority or in a hierarchy, the exemplary embodiment checks the first or highest response mode in the list for the presence or active use by the recipient of a corresponding device. In the example, the response mode of wireless communication is of the highest priority. Thus, the exemplary embodiment checks with an information source such as a home location register (HLR) for the active use of a wireless communications device by the recipient. The exemplary embodiment may check the HLR of the wireless communications device by using information about the wireless communications device obtained from the contact database and stored in association with the identity of the recipient. In particular, referring to FIG. 1, the exemplary embodiment may check, via the data network(s) 16 via the gateway 28 with an HRL such as the HLR 29. The exemplary embodiment may use the information about the wireless communications device and may communicate through the data network(s) 16 and through the wireline/wireless network(s) 14.

Assume for this example the recipient is not using his or her wireless communications device. Thus, the answer to “presence found” in action 38 of FIG. 2 is “no”. In response to determining the response mode having the highest priority fails to have an associated active device, the exemplary embodiment may check for another response mode associated with the recipient. Thus, the answer to “check another mode” in action 39 is “yes” in this example, and the exemplary embodiment returns to check for presence action 36. If the answer to “check another mode” of action 39 is a “no”, then the exemplary embodiment proceeds to action 42 in sending a response message to a default destination associated with the recipient.

In this example, after failing to find the recipient using his or her wireless unit, the exemplary embodiment checks for the presence or active use of a device associated with the next highest priority response mode: e-mail. The exemplary embodiment checks presence server 24 to determine whether the recipient is using his or her e-mail communications device such as a computer. Assume for this example the recipient is flagged as present, i.e., is using his or her computer. In other words, the answer to “presence found?” of action 38 is “yes”. In action 40, a response message is routed to the e-mail address of the recipient.

Advantageously, the exemplary embodiments of the inventions may be used with technologies such as text-to-speech (TTS), automatic speech recognition (ASR), media servers, etc. An exemplary embodiment may make use of one or more of these technologies in sending and/or communicating a response message to a recipient. For example, assume a subscriber provides a “text” response message such as an e-mail, but the recipient is active on a wireless unit and wireless communication is the recipient's highest priority response mode. The exemplary embodiment may translate the “text” response message into a “speech” response message, call the recipient's wireless unit, and deliver the “speech” response message.

In an embodiment, the IRM service may call the recipient's wireless unit and present the recipient with the option of listening to the “speech” response message. If the recipient exercises the option, the IRM service plays the “speech” response message. If the recipient elects not to listen or does not respond, the IRM service may send the response message to a default destination for the recipient.

The exemplary embodiments may include additional features and functions related to the delivery or communication of response messages. For example, an IRM service may call a recipient once the recipient is found to be actively using a wireline or wireless device. The IRM service may provide the recipient with an option to call the originator of the response. If the recipient accepts, the IRM service may cause the recipient to be bridged to the originator of the message. Alternatively, the IRM service may cause a call to be placed from the recipient's device and directed to the originator's device.

From the foregoing description of the exemplary embodiments of the inventions and operation thereof, other embodiments will suggest themselves to those skilled in the art. Therefore, the scope of the inventions is to be limited only by the claims below and equivalents thereof.

1. A method of responding to an electronic mail message (e-mail), comprising:
receiving a request to send a response to the e-mail;
using the e-mail originator address to determine a recipient for the response;
accessing response modes associated with the recipient;
determining presence of the recipient in using a device with respect to at least a response mode of the response modes associated with the recipient; and
using the response mode to transmit the response.

2. The method of claim 1, wherein the response modes associated with the recipient include a first choice of response mode;
wherein determining the presence of the recipient comprises determining the presence of the recipient in using a device corresponding to the first choice of response mode; and
wherein using the response mode to transmit the response comprises using the first choice of response mode.

3. The method of claim 2, wherein the first choice of response mode comprises an electronic mail message (e-mail); and
wherein the device corresponding to the first choice of response mode comprises a computing device.

4. The method of claim 2, wherein the first choice of response mode comprises a communication; and
wherein the device corresponding to the first choice of response mode comprises a communication unit.

5. The method of claim 4, wherein the response comprises data; and
wherein using the response mode to transmit the response comprises translating the data into speech to be used as the communication transmitted to the communication unit.

6. The method of claim 5, wherein the communication comprises a wireless communication; and
wherein the communication unit comprises a wireless unit.

7. The method of claim 5, wherein the communication comprises a wireline communication; and
wherein the communication unit comprises a wireline unit.

8. The method of claim 5, wherein using the response mode to transmit the response comprises calling the communication unit and providing a user of the communication unit with an option to hear the response.

9. The method of claim 5, wherein, instead of using the response mode to transmit the response, using the response mode to transmit an announcement to a user of the communication unit of an option to call an originator of the response.

10. The method of claim 9, wherein the user of the communication unit exercises the option by indicating a selection of the option.

11. The method of claim 10, wherein, in response to selection of the option to call the originator of the response, a call is routed from the communication unit to a device being used by the originator of the response.

12. The method of claim 1, wherein the response modes comprise a wireless communication, a wireline communication, an electronic mail message (e-mail), an instant message, or a page.

13. A system for transmitting a response to an electronic mail message (e-mail), comprising:
a response module including information associated with a user with the information including at least a recipient and at least a response mode associated with the recipient;
the response module being operative to receive a request by the user to send a response to the recipient;
the response module being operative to determine an active response mode associated with the recipient; and
the response module being further operative to transmit the response to the recipient by using the active response mode.

14. The system of claim 13, wherein the active response mode comprises a data communication; and
wherein the response module determines the active response mode associated with the recipient by consulting a presence server.

15. The system of claim 13, wherein the active response mode comprises a wireless communication; and
wherein the response module determines the active response mode associated with the recipient by consulting a home location register (HLR) of a wireless device of the recipient.

16. A method for sending a message, comprising:
storing response modes for sending messages in association with recipients of the messages;
receiving a request to send a message with respect to a received electronic mail message (e-mail);
using the received e-mail to determine a recipient for the message; and
sending the message to the recipient in a response mode corresponding to an active device of the recipient.

17. The method of claim 16, wherein sending the message to the recipient in the response mode corresponding to the active device of the recipient comprises determining the active device of the recipient.

18. The method of claim 17, wherein determining the active device of the recipient comprises checking with a presence server for the active device of the recipient.

19. The method of claim 17, wherein determining the active device of the recipient comprises checking with a home location register (HLR) for the active device of the recipient.

20. The method of claim 16, wherein the message comprises an announcement to the recipient of the option to call an originator of the message; and
wherein, in response to exercise of the option by the recipient, a call is routed from a communication unit of the recipient to a communication unit of the originator.
